(19) United States
(12) Patent Application Publication
(10) Pub. No.: US 2003/0014533 A1
(43) Pub. Date: Jan. 16, 2003

(54) Method and apparatus for facilitating attention to a communication

(76) Inventors: David P. Greene, Ossining, NY (US); Edith H. Stern, Yorktown Heights, NY (US); Philip Shi-lung Yu, Chappaqua, NY (US); Barry E. Willner, Briarcliff Manor, NY (US)

Correspondence Address: BUCKLEY, MASCHOFF, TALWALKAR, & ALLISON, 5 ELM STREET, NEW CANAAN, CT, 06840, US

(21) Appl. No.: 09/903,138

(22) Filed: Jul. 11, 2001

(51) Int. Cl. G06F 15/16

(52) U.S. Cl. 709/232

(57) ABSTRACT

A system, method, apparatus, and computer program code for facilitating attention to a communication provided by one entity to another entity and for allowing an entity to prioritize communications sent or received by the entity. A method for facilitating attention to a communication includes associating a quantity of at least one attention unit to a first entity and allowing the first entity to provide a communication to a second entity. The said communication has one or more attention units and at least one associated criterion associated with it, either by the first entity or by default. When the criterion is satisfied, the number of attention units associated with either the first entity and/or the second entity may be changed.

### FIELD OF THE INVENTION

The present invention relates to a method and apparatus for facilitating attention to a communication provided by one entity to another entity and, more particularly, embodiments of the present invention relate to methods, apparatus, and computer program code for allowing an entity to prioritize communications sent or received by the entity.

### BACKGROUND OF THE INVENTION

One unfortunate result of advancements in communication technology and channels is information overload. The ease at which people can send and receive communications such as emails, schedule requests, telephone calls, pages, etc. can often cause a person to spend a considerable amount of time processing such communications. Moreover, the person receiving a communication often does not know how high a priority to assign to the communication until the person reads or opens the communication. Members of a group or other collaborative team may send a lot of communications to each other during their association. The communications may range in importance and each communication may be sent to some or all of the members of the group or team. Even on a small scale for a group or team, the number of communications sent between members of the team may be substantial and difficult to process without some ability for each member to indicate the importance of each communication.

Some email systems allow a sender to mark an email message as urgent or high priority, thereby providing the sender with a means of describing the importance of the email message, particularly from the viewpoint of the sender. Unfortunately, such email systems does not provide incentives to senders of email messages from marking all email messages as urgent. In addition, such email systems limit a receiver of communications from accurately prioritizing communications from the viewpoint of the receiver.

It would be advantageous to provide a method and apparatus that overcame the drawbacks of the prior art. In particular, it would be desirable to provide a method and apparatus for facilitating a communication between a sender and a receiver such that both parties may prioritize the communication or otherwise associate a level or weight of importance to the communication.

### SUMMARY OF THE INVENTION

Embodiments of the present invention provide a system, method, apparatus, and computer program code for facilitating a communication between a sender of the communication and a receiver of the communication and, more particularly, to allowing the sender of the communication to indicate the importance or status of the communication to the receiver. This also allows the receiver of the communication to prioritize communications and allocated the receiver's time among communications efficiently.

Additional objects, advantages, and novel features of the invention shall be set forth in part in the description that follows, and in part will become apparent to those skilled in the art upon examination of the following or may be learned by the practice of the invention.

According to embodiments of the present invention, a method for facilitating attention to a communication includes associating one or more attention units to a first entity; allowing the entity to provide a communication to a second entity, wherein the communication has an associated number attention units and at least one associated criterion; and changing a number of attention units associated with the first entity and/or the second entity when the criterion is satisfied. In other embodiments of the present invention, a method for facilitating attention to a communication includes associating a first quantity of at least one attention unit to a first entity and a second quantity of zero or more attention units to a second entity; and changing at least one of the first quantity of attention units or the second quantity of attention units based, at least in part, on the second entity's handling of a communication received by the second entity from the first entity.

According to another embodiment of the present invention, a system for facilitating attention to a communication includes a memory; a communication port; and a processor connected to the memory and the communication port, the processor being operative to associate a quantity of at least one attention unit to a first entity; allow the first entity to provide a communication to a second entity, the communication including an associated number of at least one attention unit and at least one associated criterion; and change a number of attention units associated with at least one of the first entity and the second entity when the criterion is satisfied. In some embodiments of the present invention, a system for facilitating attention to a communication includes a memory; a communication port; and a processor connected to the memory and the communication port, the processor being operative to associate a first quantity of at least one attention unit to a first entity and a second quantity of zero or more attention units to a second entity; and change at least one of the first quantity of attention units or the second quantity of attention units based, at least in part, on the second entity's handling of a communication received by the second entity from the first entity.

According to still further embodiments of the present invention, an apparatus for facilitating attention to a communication includes means for establishing one or more attention units attention unit to a first entity; means for enabling the entity to provide a communication to a second entity, wherein the communication has an associated number attention units and at least one associated criterion; and means for adjusting a number of attention units associated with at the first entity or the second entity when the criterion is satisfied. In some other embodiments of the present invention, an apparatus for facilitating attention to a communication includes means for establishing a first quantity of at least one attention unit to a first entity and a second quantity of zero or more attention units to a second entity; and means for adjusting at least one of the first quantity of attention units or the second quantity of attention units based, at least in part, on the second entity's handling of a communication received by the second entity from the first entity.

In further embodiments of the present invention, a computer program product in a computer readable medium for facilitating attention to a communication includes first instructions for establishing an amount of at least one attention unit to a first entity; second instructions for enabling the first entity to send a communication to a second entity having an associated number of at least one attention unit and an associated criterion; and third instructions for altering a number of attention units associated with at least one of the first entity and the second entity when the second criterion is satisfied. In other embodiments, a computer program product in a computer readable medium for facilitating attention to a communication includes first instructions for establishing a first quantity of at least one attention unit to a first entity and a second quantity of zero or more attention units to a second entity; and second instructions for changing at least one of the first quantity of attention units or the second quantity of attention units based, at least in part, on the second entity's handling of a communication received by the second entity from the first entity.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate embodiments of the present invention, and together with the descriptions serve to explain the principles of the invention.

FIG. 1 is a flowchart of a first embodiment of a method in accordance with the present invention;

FIG. 2 is a flowchart of a second embodiment of a method in accordance with the present invention;

FIG. 3 is a block diagram of system components for an embodiment of an apparatus usable with the method of FIG. 1;

FIG. 4 is a block diagram of a server of FIG. 3;

FIG. 5 is an illustration of a representative entity information database of FIG. 4; and

FIG. 6 is an illustration of a representative communication information database of FIG. 4.

### DETAILED DESCRIPTION

Applicants have recognized that there is a need for systems and methods, which allow a sender of a communication to indicate the communication's importance or status to one or more receivers of the communication. In addition, applicants have recognized that there is a need to provide incentives for a sender of communications to accurately indicate a level of status or importance for each communication provided by the sender. Embodiments of the present invention provide such capabilities, by providing a sender, or a group of senders, with a quantity of attention units. A sender of a communication, such as an email message, schedule request, telephone (including cellular) call, voice message, etc., may indicate the importance of the communication by associating a number of the sender's attention units to the communication. For example, in some embodiments, a sender may be allocated a specific, minimum or maximum number of attention units to use with communications sent by the sender during a given time period. Thus, while the sender may choose how many attention units to associate with a given communication, the sender may not exceed the number of usable attention units that the sender has or may otherwise use. In other embodiments, the sender may be able to purchase or acquire additional units, perhaps at some cost or loss of other resource. Similarly, the sender may be able to use more than the sender's allocated number of attention units for communications, thereby creating a deficit of attention units for the sender that the sender may have to make up in the future or otherwise provide compensation for.

For purposes of this disclosure, “attention units” shall mean any points, values, numbers, ranks, scores, currency, exchange constituents, components, elements, divisions, parts, units, or other items or information which may be used to signify or indicate ranking or level of importance or status for a communication. Thus, attention units may be intangible quantities or numbers used for purpose of the present invention. In some embodiments, attention units also may be viewed as fungible units, items, resources, assets, etc., the possession, ownership or control of which provides value, status, etc. In some embodiments, a market, bank or other exchange may be established for the purchase, sale, borrowing, auction, loan, transfer, etc. of one or more attention units so that groups, individuals, departments, etc. can have an efficient means of exchanging the attention units. In some embodiments, a minimum or maximum number of attention units that an entity may earn, transfer, borrow, lend, sell, purchase, etc. may be established.

In some embodiments of the present invention, a sender may not lose attention units when the sender provides a communication to a user. Different members of a group may be allocated different quantities of attention units so that a more prioritized person in the group can allocate a greater number of attention units to a communication than can a junior or less prioritized person in the group.

In some embodiments of the present invention, a sender may be charged or debited attention units associated with a communication when the communication is received by a receiver. The number of attention units charged to the sender may be the number of attention units associated by the sender with the communication. Since the sender may desire to send a number of communications during a given time period, the sender has an incentive to allocate attention units carefully to a communication so as to ensure that the sender will have attention units available for later communications.

In some embodiments of the present invention, a receiver of a communication may receive attention units for a communication handled upon by the receiver. The number of attention units added to the receiver's quantity of attention units might be equal to the number of attention units associated with the communication by a sender of the communication. Thus, the receiver is motivated to handle the communication. If the receiver receives multiple communications, the receiver may prioritize his or her handling of the communications based on the number of attention units associated with the individual communications by the senders of the communications. In some embodiments, fractional portions of an attention unit may be allocated, provided, transferred or otherwise used. Fractional portions of an attention unit may be combined to form a full attention unit. In some embodiments, a fractional attention unit may be associated with a communication.

“Handling” of a communication may occur in a variety of ways. In some embodiments, a sender of a communication may associate a criterion with the communication that the receiver of the communication may have to satisfy. For example, a sender of an email message (i.e., a communication) having an associated number of attention units may designate that the receiver of the email message must open the email message, respond to the email message, save the email message, forward the email message, etc. as part of “handling” of the communication. If the receiver does not satisfy the criterion associated with the communication, the sender may not lose the number of attention units associated with the email message. In addition, the receiver may not obtain use of or receive the number of attention units associated with the email message. As another example, a sender of a schedule request (i.e., a communication) having an associated number of attention units may designate that the receiver of the schedule request must accept the schedule request as part of “handling” of the communication. As a further example, a sender of an email message having an associated number of attention units may designate that the receiver of the email message must complete a request included in or with the email message as part of “handling” of the communication. In addition, some portion less than the full number of associated attention units may be credited to the receiver and debited from the sender with respect to the level of handling that occurred.

In some embodiments, a criterion may be associated with a communication by default or implication. For example, if no criterion is explicitly associated with an email message by a sender of the email message, a receiver of the email message may be considered or assumed to have satisfactorily handled the communication, and satisfied the email message's associated criterion, if the receiver opens the email message or responds to the email message. Thus, the criterion is associated by default to the email message. As another example, if no criterion is explicitly associated with a schedule request by a sender of the schedule request, a receiver of the schedule request may be considered or assumed to have satisfactorily handled the communication, and satisfied the schedule request's associated criterion, if the receiver accepts the schedule request.

In some embodiments, attention units may function as a signaling mechanism related to allocation of resources or a need to reconfigure components of a system. For example, shifting of attention units toward a group (e.g., a group of employees) or individual (e.g., an employee) within a company may indicate that the group or individual is popular or more vital to the company's well-being or success. Thus, such group or individual may be allocated more attention units than other groups or individuals. Understanding the ebb and flow of attention units between individuals, groups, etc. of a company, etc. may allow the company to understand the attention needed to be given by the individuals or groups, to understand the value of a specific individual or department, etc. For example, a specific individual or department in a company may be informally consulted by a lot of other employees within the company on projects, ideas, etc. both directly and indirectly related to the individual's or department's specific job function. Thus, the individual or department may possess great value to the company far ahead of what might be considered or recognized given the person's or department's job function, company role, or title. Monitoring the use of attention units in communications to the individual or department, which can be done independently of monitoring the content of the communications themselves, may help identify the individual, department, etc. as a significant contributor to the success of the company.

In some embodiments, attention units may be bought, sold, loaned, traded, exchanged, transferred, etc. Thus, attention units form a resource within a system. Allowing change or reallocation of ownership or control over use of attention units allows the resource to be used most efficiently by participants. For example, one individual may loan a second individual fifty attention units that the first individual does not currently need and the second individual does not currently have and later receive fifty-five attention units in return as repayment and an interest payment. Thus, the attention units may be a form of currency that can be traded, allocated or reallocated within an organization or group of individuals based on whatever criteria, if any, the organization or group might establish or use. As another example, an individual or group may be allowed to run or generate a deficit number of attention units or have a negative number of attention units. Thus, the individual or group is not prevented from sending or receiving communications due to a lack of attention units. Rather, the individual or group may have to sacrifice or forego use of another asset or resource to compensate for the overuse of attention units. Alternatively, running or creating a deficit or negative number of attention units may be used in evaluating or critiquing the individual or group.

In addition, in some embodiments, one or more attention units might be “revalued” as conditions or usage patterns change, become recognized or established, or evolve. Thus, one attention unit may be revalued to equal two attention units. Alternatively, one attention unit may be revalued to equal one-third of an attention unit.

These and other features will be discussed in further detail below, by describing a system, individual devices, and processes according to embodiments of the invention.

Process Description

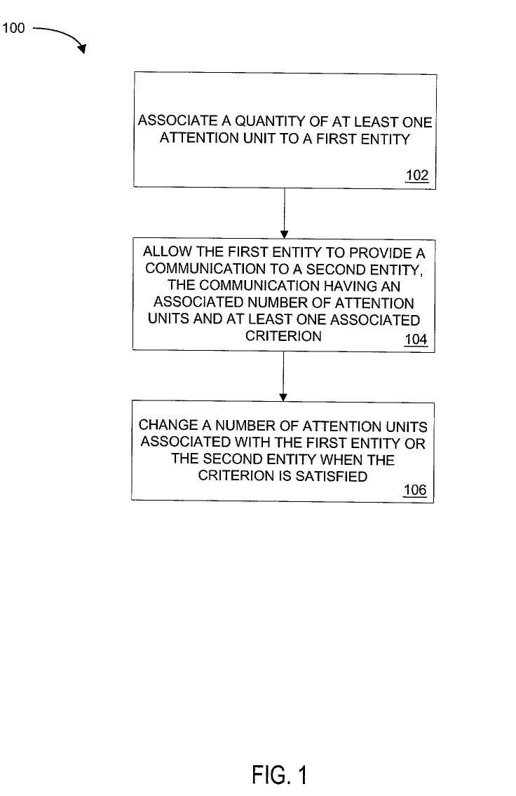

Reference is now made to FIG. 1, where a flow chart 100 is shown which represents the operation of an embodiment of the present invention. The particular arrangement of elements in the flow chart 100 is not meant to imply a fixed order to the steps; embodiments of the present invention can be practiced in any order that is practicable. In some embodiments, some or all of the steps of the method 100 may be performed or implemented by a server or other device.

Processing begins at a step 102 where one or more attention units are provided or otherwise associated with an entity, such as a person in a work group, a company employee, etc., which may include providing the attention units, or an indication of the attention units to a device associated with the entity (e.g., computer, personal digital assistant, cellular telephone).

In some embodiments of the method 100, attention units may be allocated to more than one entity. Some or all of the entities may receive the same or different numbers of attention units.

Attention units may be allocated in many ways and by a person, group or device. For example, a workgroup leader may allocate attention units to members of the workgroup for use when sending communications to members of the workgroup. As another example, a company's human resource director or a device, such as a computer, server or controller, may allocate attention units to employees of the company. In some embodiments, one or more of the attention units associated with an entity during the step 100 may have an expiration date associated with them so that the entity cannot hoard attention units, build up a large supply of attention units, or use certain attention units beyond a designated time or time period. Different attention units, or groups of attention units, may have different expiration dates associated with them.

During a step 104, the entity is allowed to send or otherwise provide a communication to another entity. The communication may have one or more attention units associated and at least one criterion associated with it. In some embodiments, the entity may send the communication to more than one other entity. Attention units associated by or for a sender of a communication also may be referred to herein as attention spend units. The communication may be a technology mediated communication, a technology facilitated communication, or some other form or type of communication.

Attention units may be associated with or to a communication in a variety of ways. For example, an entity may explicitly designate how many attention units are to be associated with a communication. Alternatively, each type (e.g., email message, voicemail message, schedule request) of communication may have a minimum, maximum or exact number of attention units associated with it. As a further example, the number of attention units associated to the communication may be based on, in whole or in part, the status, rank or importance of the person sending or receiving the communication.

A criterion also may be associated with or to a communication in a variety of ways. In some embodiments, an entity may expressly designate or associate a criterion with a communication. For example, an entity sending an email message may establish the criterion to be a receiver of the email message opening the email message, storing the email message, forwarding the email message, etc. Alternatively, the entity may designate that a receiver of an email message must respond to a request included within or attached to the email message, the request being the criterion associated with the communication.

In some embodiments, the criterion associated with the communication may be established or otherwise associated by default or other implication. For example, if no criterion is explicitly associated by an entity with a voicemail message left by the entity, a receiver of the voicemail message may be considered or assumed to have satisfactorily handled the communication, and satisfied the voicemail's associated criterion, if the receiver listens to the voicemail message. Thus, the criterion of listening to the voicemail message is associated by default to the voicemail message. As another example, if no criterion is explicitly associated with a telephone call made by an entity, a receiver of the telephone call may be considered or assumed to have satisfactorily handled the communication, and satisfied the telephone call's associated criterion, if the receiver answers or accepts the call.

In some embodiments, information regarding attention units and/or criteria associated with a communication may be provided to a receiver of the communication as part of the communication itself. For example, the subject line of a conventional email message may include information regarding the number of attention units and/or a criterion associated with the email message. An electronic schedule or other meeting request may include similar information. As another example, a voicemail message may include a portion of audible information describing the number of attention units and/or any criterion associated with the voicemail message.

In some embodiments, information regarding attention units and/or criteria associated with a communication may be provided to a receiver of the communication separate from the communication.

During a step 106, the number of attention units associated with the entity sending the communication and/or the entity receiving the communication may be changed when the criterion associated with the communication is satisfied. For example, a sending entity's supply of attention units may be decreased by the number of attention units associated with a communication when the criterion associated with the communication is satisfied. As another example, a receiving entity's supply of attention units may be increased by the number of attention units associated with the communication when the criterion associated with the communication is satisfied. The receiver may be able to use the new attention units for communications made by the receiver.

In some embodiments, a receiving entity's number of attention units may be increased by the number of attention units associated with the communication when the criterion associated with the communication is satisfied, however, the receiver is not allowed to use such attention units, referred to herein as attention receipt units. Thus, an entity's attention units available for use with communications (e.g., attention spend units) may be decrease each time the entity provides or makes a communication. A receiving entity's attention receipt units may increase each time the receiving entity satisfies a criterion associated with the communication. In this type of implementation, a greater number of attention spend units for an entity may indicate the entity's frugalness in using attention units for communications sent by or from the entity while a greater number of attention receipt units for the entity may indicate the entity's responsiveness to communications sent to the entity. An entity's number of attention spend units, attention receipt units, or total attention units may be used to evaluate or reward an entity for efficient communication, responsiveness to communications, etc. Thus, an entity may receive compensation or other benefit based, in whole or in part, on how the entity uses or allocates attention units, how many attention units the entity controls, possesses, owns, or is otherwise associated with, how many different people the entity has received attention units from, etc. A reward or benefit may be a monetary and/or non-monetary amount.

As another example of how the method 100 might be used, a customer purchasing a product from a company may be provided with a number of attention units that the customer can use when seeking help or other customer service from the company. Whenever the customer sends or makes an inquiry to the company (i.e., a communication), the customer allocates some of the attention units to the inquiry. The customer's supply of attention units may be decreased each time the company responds to an inquiry from the customer. A criterion may be associated with the communication by default. For example, it may be assumed by default that the criterion associated with each inquiry sent by the customer to the company is that the company must respond to the inquiry.

The customer is allowed to make inquiries until all of the attention units allocated to the customer are gone. Of course, the company may provide additional attention units to the customer from time to time at the company's discretion. Each customer inquiry may have a minimum number of attention units associated with it.

With this arrangement, the customer can allocate attention units to each inquiry that the customer makes of the company. Thus, the customer has control and flexibility regarding the level of service the customer is requesting from the company. In addition, the company provides customer service to the customer, but is not required to provide all customer service at an urgent level. If the customer makes inquiries frequently, the customer will run out of attention units quickly or have to accept a lower level of customer service from the company for each inquiry. If the customer makes inquires less often, the customer can allocate more attention units to each inquiry.

In some embodiments, entities may be allowed to dispute when a criterion associated with a communication has been satisfied or to indicate or deny that the criterion has been satisfied. In such embodiments a notification of a dispute regarding satisfaction or completion of a criterion associated with a communication might be sent or received by the device or entity implementing the method 100.

As previously discussed above, in some embodiments of the method 100, an entity may be allowed to purchase, sell, borrow, loan, etc. one or more attention units. Thus a market for attention units may be established. The method 100 may include a step of allowing a first entity to purchase or borrow one or more attention units from a second entity, allowing a first entity to sell or lend one or more attention units to a second entity, allowing fractions or portions of attention units to be combined, sold, purchased, transferred, etc., allowing an entity to earn or otherwise acquire one or more attention units, allowing an entity to lose or lose use of one or more attention units, establishing an exchange for attention units, revaluing or reallocating one or more attention units, etc.

Entities or devices also may be allowed to access attention unit accounts to update or verify entity, communication or attention unit information. Such information may be kept in an attention unit database and/or a communication database. Information about entities may be kept in an entity information database.

In some embodiments, a minimum and/or maximum number of attention units may be determined that can be used with one or more communications. In addition, in some embodiments, a minimum and/or maximum number of attention units that can be used by one or more entities during a given time period also may be determined.

In some embodiments, entities may be able to transfer or barter non-used or non-needed attention units, especially attention spend units, between one another or have such bartering done automatically on their behalf. If desired, limits might be placed on the number of attention units that can be transferred between entities. In some embodiments, a notification of a completion of the criterion, or a confirmation of such completion, might be received or sent by the entity or device implementing the method 100.

In some embodiments, a device or entity implementing the method 100 may providing a notification indicative of a minimum and/or maximum number of attention units that can be used with a communication, a notification indicative of a minimum and/or maximum number of attention units that can be used by ant entity, or some other notification. In some embodiments, a device or entity implementing the method 100 may receive a message or other notification from an entity regarding how many attention units are associated with a communication, how many attention units an entity wants to sell, lend, purchase, borrow, transfer, earn, etc., how many attention units the entity has available, etc. Any request, message, command, or other communication or notification that may be sent or received, may be in any form or format, including, but not limited to, a HTTP (Hypertext Transfer Protocol), HTML (Hypertext Mark-up Language) or FTP (File Transfer Protocol) transmission, XML (Extensible Mark-up Language) feed, email message, instant message communication, facsimile or radio transmission, telephone call, electronic signal or communication, etc.

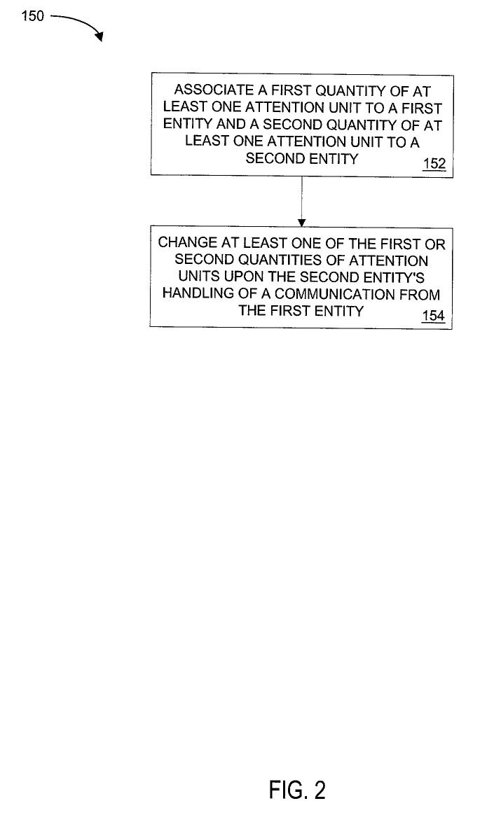

Reference is now made to FIG. 2, where a flow chart 150 is shown which represents the operation of an embodiment of the present invention. The particular arrangement of elements in the flow chart 150 is not meant to imply a fixed order to the steps; embodiments of the present invention can be practiced in any order that is practicable. In some embodiments, some or all of the steps of the method 150 may be performed or implemented by a server or other device.

Processing begins at a step 152, where a first quantity of one or more attention units is associated with a first entity and a second quantity of one or more attention units is associated with a second entity. Allocation or other association of attention units to entities may be completed in a variety of ways, as previously discussed above. The first and second entities may be allocated a different number of attention units. The attention units allocated during the step 152 may be attention spend units. The method 150 may include some or all of the variations previously discussed above.

During a step 154, the number of attention units associated with the first entity and/or the second entity are changed depending on how the second entity handles a communication received by the second entity from the first entity. For example, the number of attention units associated with the first entity may be decreased and/or the number of attention units associated with the second entity increased by an equal amount when the second entity satisfies a criterion associated with the communication. Alternatively, the number of attention spend units associated with the first entity may be decreased when the second entity satisfies a criterion associated with the communication. However, the second entity's number of attention spend units may not be increased. Rather, the second entity's number of attention receipt units may be increased by the amount of decrease in the first entity's attention spend units.

In some embodiments, the amount of change in the first and/or second entity's attention units may be determined by how the second entity handles the communication. The first entity's number of attention units may decrease by a designated amount if the second entity performs one action in response to the communication and a different amount if the second entity performs a different action in response to the communication. For example, if the communication is an email message, the first entity may lose or be charged ten attention units if the second entity receives the email message, twenty attention units if the second entity opens the email message, fifty attention units if the second entity responds to the email message, and thirty attention units if the second entity forwards or saves the email message. As another example, if the communication is a meeting or schedule request, the first entity may lose or be charged five attention units if the second entity receives the meeting request, twenty attention units if the second entity accepts the meeting message, and fifteen fifty attention units if the second entity declines the meeting request but suggests a different meeting time back to the first entity. As a another example, if the communication is an email message that contains a request that the second entity perform some designated action, the first entity may lose or be charged five attention points if the second entity opens the email message and fifty attention units if the second entity completes the request contained within the email message.

System

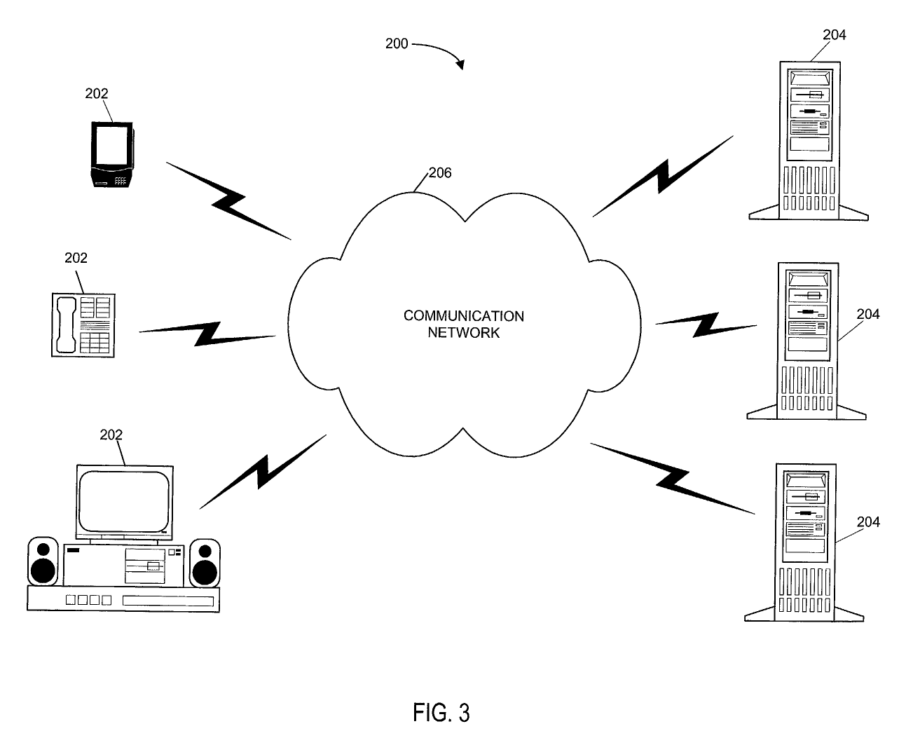

Now referring to FIG. 3, an apparatus or system 200 usable with the methods 100 and 150 is illustrated. The apparatus 200 includes one or more user devices 202 that may communicate directly or indirectly with one or more servers, controllers or other devices 204 via a computer, data, or communications network 206. For purposes of further explanation and elaboration, but not limitation, of the methods 100 and 150, the method 100 and 150 will be assumed to be operating on, or under the control of, one the servers 204.

A server 204 may implement or host a Web site. A server 204 can comprise a single device or computer, a networked set or group of devices or computers, a workstation, etc. In some embodiments, a server 204 also may function as a database server and/or as a user device. A server 204 may be an entity for purposes of the present invention. The use, configuration and operation of servers will be discussed in more detail below.

The user devices 202 preferably allow entities to interact with the server 204 and the remainder of the apparatus 200. The user devices 202 also may enable an entity to access Web sites, software, databases, etc. hosted or operated by the servers 202. If desired, the user devices 202 also may be connected to or otherwise in communication with other devices. Possible user devices include a personal computer, portable computer, mobile or fixed user station, workstation, network terminal or server, smart or cellular telephone, kiosk, dumb terminal, personal digital assistant, two-way pager, cable set-top box, etc.

Many different types of implementations or hardware configurations can be used in the system 200 and with the methods 100, 150, and the methods disclosed herein are not limited to any specific hardware configuration for the system 200 or any of its components.

The communications network 206 might be or include the Internet, the World Wide Web, or some other public or private computer, cable, telephone, data, peer-to-peer or other communications network or intranet, as will be described in further detail below. The communications network 206 illustrated in FIG. 3 is only meant to be generally representative of cable, computer, telephone or other communication networks for purposes of elaboration and explanation of the present invention and other devices, networks, etc. may be connected to the communications network 206 without departing from the scope of the present invention. The communications network 206 can also include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 204 without departing from the scope of the present invention. Moreover, as used herein, communications include those enabled by wired or wireless technology.

In some embodiments, a suitable wireless communication network 206 may include the use of Bluetooth technology, allowing a wide range of computing and telecommunication devices to be interconnected via wireless connections. Specifications and other information regarding Bluetooth technology are available at the Bluetooth Internet site www.bluetooth.com. In embodiments utilizing Bluetooth technology, some or all of the devices of FIG. 3 may be equipped with a microchip transceiver that transmits and receives in a previously unused frequency band of 2.45 GHz that is available globally (with some variation of bandwidth in different countries). In addition to data, up to three voice channels are available. Connections can be point-to-point or multipoint over a current maximum range of ten (10) meters. Embodiments using Bluetooth technology may require the additional use of one or more receiving stations to receive and forward data from individual user devices 202 or servers 204.

Although three user devices 202 and three servers 204 are shown in FIG. 3, any number of such devices may be included in the system 200. The devices shown in FIG. 3 need not be in constant communication. For example, in some embodiments, a user device may communicate with a server only when such communication is appropriate or necessary.

Server

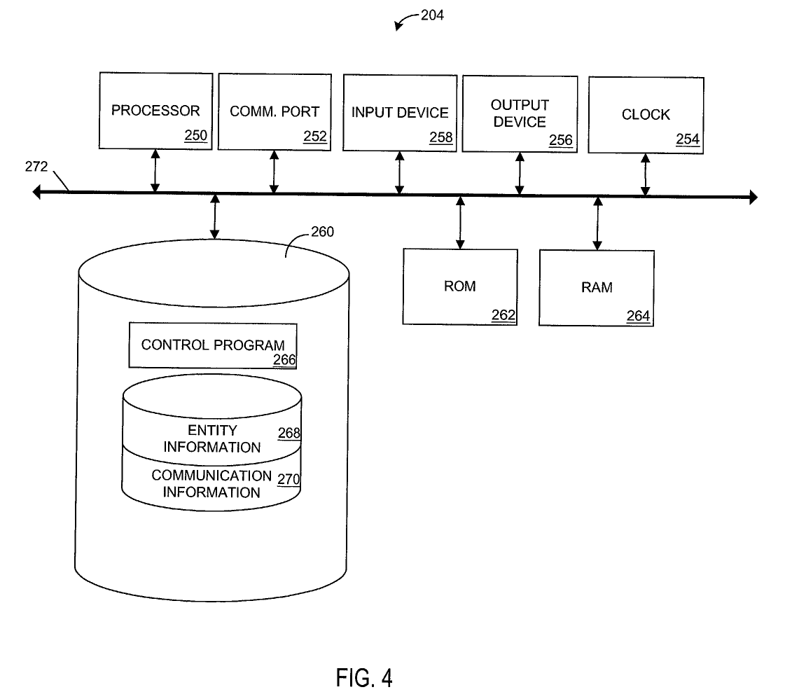

Now referring to FIG. 4, a representative block diagram of a server 204 is illustrated. The server 204 may include a processor, microchip, central processing unit, or computer 250 that is in communication with or otherwise uses or includes one or more communication ports 252 for communicating with user devices and/or other devices. Communication ports may include such things as local area network adapters, wireless communication devices, Bluetooth technology, etc. The server 204 also may include an internal clock element 254 to maintain an accurate time and date for the server 204, create time stamps for communications received or sent by the server 204, etc.

If desired, the server 204 may include one or more output devices 256 such as a printer, infrared or other transmitter, antenna, audio speaker, display screen or monitor, text to speech converter, etc., as well as one or more input devices 258 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 204 may include a memory or data storage device 260 to store information, software, databases, communications, entity information, attention unit information, device drivers, etc. The memory or data storage device 260 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 204 also may include ROM 262 and RAM 264 for memory and storage.

The processor 250 and the data storage device 260 in the server 204 each may be, for example: (i) located entirely within a single computer or other computing device; or (ii) connected to each other by a remote communication medium, such as a serial port cable, telephone line or radio frequency transceiver. In one embodiment, the server 204 may comprise one or more computers that are connected to a remote server computer for maintaining or accessing databases.

A conventional personal computer or workstation with sufficient memory and processing capability may be used as the server 204. In one embodiment, the server 204 operates as or includes a Web server for an Internet environment. The server 204 preferably is capable of high volume transaction processing, performing a significant number of mathematical calculations in processing communications and database searches. A Pentium™ microprocessor such as the Pentium III™ microprocessor, manufactured by Intel Corporation may be used for the processor 250. Equivalent processors are available from Motorola, Inc., AMD, or Sun Microsystems, Inc. The processor 250 also may comprise one or more microprocessors, computers, computer systems, etc.

Software may be resident and operating or operational on the server 204. The software may be stored on the data storage device 260 and may include a control program 266 for operating the server, databases, etc. The control program 266 may control the processor 250. The processor 250 preferably performs instructions of the control program 266, and thereby operates in accordance with the present invention, and particularly in accordance with the methods described in detail herein. The control program 266 may be stored in a compressed, uncompiled and/or encrypted format. The control program 266 furthermore includes program elements that may be necessary, such as an operating system, a database management system and device drivers for allowing the processor 250 to interface with peripheral devices, databases, etc. Appropriate program elements are known to those skilled in the art, and need not be described in detail herein.

The server 204 also may include or store information regarding entities, communications, attention units, etc. For example, information regarding entities may be stored in an entity database 268 for use by the server 204 or another device or entity. Similarly, information regarding communications may be stored in a communication database 270 for use by the server 204 or another device or entity.

According to an embodiment of the present invention, the instructions of the control program may be read into a main memory from another computer-readable medium, such as from the ROM 262 to RAM 264. Execution of sequences of the instructions in the control program causes the processor 250 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 250, communication port 252, clock 254, output device 256, input device 258, data storage device 260, ROM 262, and RAM 264 may communicate or be connected directly or indirectly in a variety of ways. For example, the processor 250, communication port 252, clock 254, output device 256, input device 258, data storage device 260, ROM 262, and RAM 264 may be connected via a bus 272.

While specific implementations and hardware configurations for servers 204 devices have been illustrated, it should be noted that other implementations and hardware configurations are possible and that no specific implementation or hardware configuration is needed. Thus, not all of the components illustrated in FIG. 4 may be needed for a server implementing the method 100 or the method 150. Therefore, many different types of implementations or hardware configurations can be used in the system 200 and the methods disclosed herein are not limited to any specific hardware configuration.

User Device

As mentioned above, user device 202 may be or include any of a number of different types of devices, including, but not limited to a personal computer, portable computer, mobile or fixed user station, workstation, network terminal or server, telephone, beeper, kiosk, dumb terminal, personal digital assistant, facsimile machine, cable set-top box, cash register, etc. If desired, the user device 202 also may function as a server 204. A user device 202 may be operated by or on behalf of any of a number of different entities that are interested in sending or receiving communications, attention unit information, etc. In some embodiments, a user device 202 may have the same structure or configuration as the server 204 illustrated in FIG. 3 and some or all of the components of the server 204 illustrated in FIG. 3.

Databases

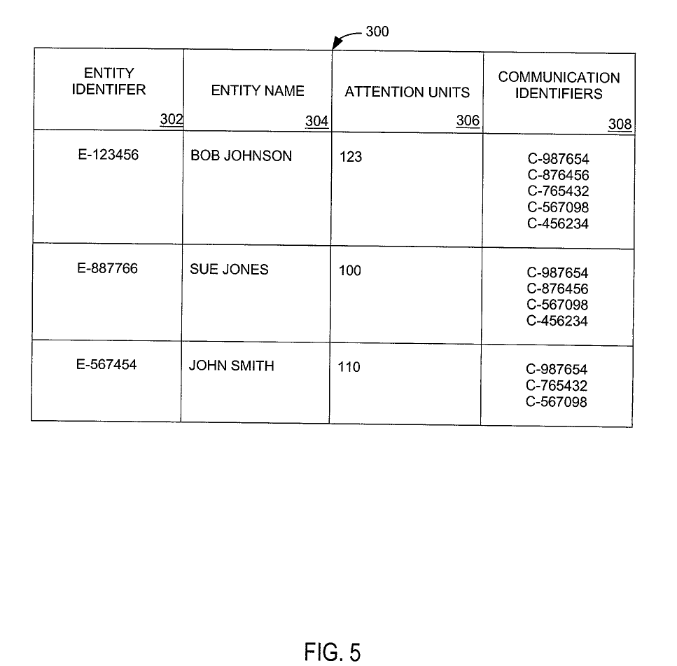

As previously discussed above, in some embodiments a server 204 may include an entity database for storing or keeping information about one or more entities. One representative communication database 300 is illustrated in FIG. 5. The entity database 300 may include an entity identifier field 302 which may include identifiers or other numerical codes associated with entities, an entity name field 304 which may include names and other descriptive information for the entities identified in the field 302, an attention unit field 306 which may include information regarding the number of attention units allocated to the entities identified in the field 302, and a communications identifier field 308 which may include identifiers or other numerical codes associated with communications involving the entities identified in the field 302. Other or different fields also may be used in the communications database 400.

As illustrated by the representative entity database 300 of FIG. 5, the entity identified as “BOB JOHNSON” in the field 304 has an associated identifier “E-123456”, as indicated in the field 302 and a total of 123 available attention units, as indicated in the field 306. The entity identified as “BOB JOHNSON” in the field 304 has been involved, either as a sender or receiver, in five communications identified as “C-987654”, “C-876456”, “C-765432”, “C-567098” and “C-456234”. Information regarding these communications might be found in a communications database.

Information regarding entities may be added or updated in the entity database 268 when an entity makes a communication, processes a communication, etc. A user device 202 or a server 204 may access the entity database 300 when sending or receiving a communication, verifying that an entity has enough attention units to send a communication, verifying that an entity has enough attention units to cover the attention units associated by the entity (either directly or by default) to a communication, etc.

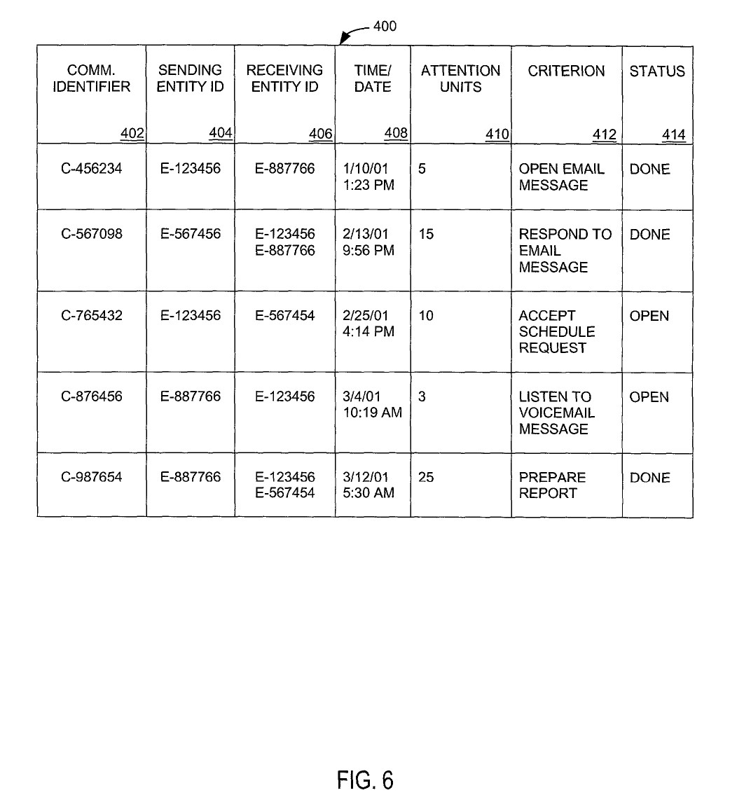

As previously discussed above, in some embodiments a server 204 may include a communication database for storing or keeping information about communications between two or more entities. One representative communication database 400 is illustrated in FIG. 6. The communication database 400 may include a communication identifier field 402 which may include identifiers or other numerical codes associated with communications to distinguish communications, a sending entity identifier field 404 which may include sending entity identifier or other information for the communications identified in the field 402, a receiving entity identifier field 406 which may contain receiving entity identifier or information regarding for the communications identified in the field 402, a time/date field 408 which may contain information regarding the time and date the communications identified in the field 402 were sent, an attention units field 410 which may contain information regarding the number of attention units associated with the communications identified in the field 402, a criterion field 412 which may contain information regarding one or more criterions associated directly or by default with the communications identified in the field 402, and a status field 414 which may contain information regarding whether the criterions described in the field 412 have been completed for the communications identified in the field 402. Other or different fields also may be used in the communications database 400.

The communication identified as “C-456234” in the field 402 of the communication database 400 was sent by the entity identified as “E-123456” in the field 404 and received by the entity identified “E-887766” in the field 406. As illustrated in the entity database, the entity identified as “E-123456” in the field 404 is “BOB JOHNSON” and the field 404 and received by the entity identified “E-887766” in the field 406 is “SUE JONES”. The entity “BOB JOHNSON” sent the communication identified as “C-456234” on Jan. 10, 2001, at 1:23 pm, as indicated in the field 408 of the communication database 400. The communication identified as “C-456234” has five attention units associated with it, as indicated by the field 410, and a criterion associated with it that requires that the communication, presumably an email message, be opened by the receiving entity (“SUE JONES”), as indicated in the field 412. According the entry in the status field 414 for the communication identified as “C-456234”, the criterion associated with the communication is satisfied or “DONE.”

Some communications may be sent to more than one receiving entity, as indicated by the entry in the field 406 for the communication identified as “C-567098” in the field 402. In addition, for a communication having a criterion associated with it that has not be satisfied or completed, the communication may have a status of “OPEN”, as indicated by the entry in the field 414 for the communication identified as “C-876456” in the field 402.

Information regarding communications may be added or updated in the communication database 20 when an entity makes a communication, processes a communication, etc. A user device 202 or a server 204 may access the communication database 400 when sending or receiving a communication, verifying that an entity has enough attention units to send a communication, verifying that an entity has enough attention units to cover the attention units associated by the entity (either directly or by default) to a communication, checking or verifying a status of a communication, etc.

Although the present invention has been described with respect to a preferred embodiment thereof, those skilled in the art will note that various substitutions may be made to those embodiments described herein without departing from the spirit and scope of the present invention.

The methods 100, 150 of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods 100, 150 can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for facilitating attention to a communication, comprising:
associating a quantity of at least one attention unit to a first entity;
allowing said first entity to provide a communication to a second entity, wherein said communication has an associated number of at least one attention unit and at least one associated criterion; and
changing a number of attention units associated with at least one of said first entity and said second entity when said criterion is satisfied.

2. The method of claim 1, wherein said communication comprises an email message.

3. The method of claim 2, wherein said criterion includes at least one of the following:
satisfying a request included in said communication;
said second entity receiving said email message;
said second entity opening said email message;
said second entity opening an attachment to said email message;
said second entity responding to said email message;
said second entity saving said email message; and
said second entity forwarding said email message.

4. The method of claim 1, wherein said communication comprises a meeting request.

5. The method of claim 4, wherein said criterion includes at least one of the following:
satisfying a request included in said communication;
said second entity receiving said meeting request;
said second entity opening said meeting request;
said second entity responding to said meeting request;
said second entity accepting said meeting request; and
said second entity forwarding said meeting request.

6. The method of claim 1, wherein said communication comprises a voicemail message.

7. The method of claim 6, wherein said criterion includes at least one of the following:
satisfying a request included in said communication;
said second entity receiving said voicemail message;
said second entity playing said voicemail message;
said second entity responding to said voicemail message;
said second entity saving said voicemail message; and
said second entity forwarding said voicemail message.

8. The method of claim 1, wherein said communication comprises a telephone call.

9. The method of claim 8, wherein said criterion includes at least one of the following:
satisfying a request included in said communication;
said second entity receiving said telephone call;
said second entity answering said telephone call; and
said second entity responding to said telephone call.

10. The method of claim 1, further comprising:
confirming completion of said criterion prior to said changing said second entity's attention units.

11. The method of claim 1, further comprising:
associating said criterion with said communication.

12. The method of claim 1, further comprising:
allocating a plurality of attention units among a plurality of entities, said plurality of entities including said first entity and said second entity, wherein each of said entities in said plurality of entities is allocated zero or more attention units, wherein said allocating includes said associating a quantity of at least one attention unit to a first entity.

13. The method of claim 12, further comprising:
allowing an entity from said plurality of entities to acquire additional attention units.

14. The method of claim 12, further comprising:
evaluating an entity from said plurality of entities based, at least in part, on a number of attention units associated with said entity.

15. The method of claim 1, further comprising:
providing a benefit to an entity from said plurality of entities based, at least in part, on a number of attention units associated with said entity.

16. The method of claim 1, further comprising at least one of the following:
establishing a maximum number of attention units can be associated with said first entity;
establishing a maximum number of attention units that can be acquired by said first entity;
establishing a maximum number of attention units that can be loaned by said first entity;
establishing a maximum number of attention units that can be borrowed by said first entity;
establishing a maximum number of attention units that can be sold by said first entity;
establishing a maximum number of attention units that can be purchased by said first entity;
establishing a maximum number of attention units that can be transferred by said first entity;
establishing a maximum number of attention units that can be earned by said first entity;
establishing a maximum number of attention units that can be used by said first entity during a time period;
establishing a maximum number of attention units that can be used by said first entity for said communication;
providing a notification indicative of a maximum number of attention units that can be used with said communication;
providing a notification indicative of a maximum number of attention units that can be used by said first entity;
establishing a minimum number of attention units can be associated with said first entity;
establishing a minimum number of attention units that can be acquired by said first entity;
establishing a minimum number of attention units that can be loaned by said first entity;
establishing a minimum number of attention units that can be borrowed by said first entity;
establishing a minimum number of attention units that can be sold by said first entity;
establishing a minimum number of attention units that can be purchased by said first entity;
establishing a minimum number of attention units that can be transferred by said first entity;
establishing a minimum number of attention units that can be earned by said first entity;
establishing a minimum number of attention units that can be used by said first entity during a time period;
establishing a minimum number of attention units that can be used by said first entity for said communication;
providing a notification indicative of a minimum number of attention units that can be used with said communication; and
providing a notification indicative of a minimum number of attention units that can be used by said first entity.

17. The method of claim 1, further comprising at least one of the following
receiving data indicative of said associated number of at least one attention unit;
receiving a communication from said first entity, wherein said communication includes data indicative of said associated number of at least one attention unit;
establishing a minimum number of attention units that can be associated with said communication; and
establishing a maximum number of attention units that can be associated with said communication.

18. The method of claim 1, wherein said criterion is associated with said communication by default.

19. The method of claim 1, wherein said changing said second entity's attention units includes increasing said second entity's attention units by said number of at least one attention unit.

20. The method of claim 19, further comprising:
decreasing said quantity of attention units by said number of at least one attention unit.

21. The method of claim 1, further comprising:
establishing an expiration date for at least a portion of said quantity of at least one attention unit.

22. The method of claim 1, further comprising:
maintaining a count of attention receipt units associated with said second entity.

23. The method of claim 1, further comprising:
receiving a notification of a completion of said criterion.

24. The method of claim 1, further comprising:
receiving a notification of a dispute regarding completion of said criterion.

25. The method of claim 1, further comprising at least one of the following:
establishing an exchange for the transfer of attention units;
allowing said first entity to run a deficit number of attention units;
allowing said first entity to earn at least one attention unit;
allowing said first entity to purchase at least one attention unit;
allowing said first entity to purchase at least one attention unit;
allowing said first entity to sell at least one attention unit;
allowing said first entity to borrow at least one attention unit;
allowing said first entity to lend at least one attention unit;
allowing said first entity to transfer at least one attention unit;
allowing said first entity to acquire control of at least one attention unit; and
allowing said first entity to transfer control of at least one attention unit.

26. A method for facilitating attention to a communication, comprising:
associating a first quantity of at least one attention unit to a first entity and a second quantity of zero or more attention units to a second entity; and
changing at least one of said first quantity of attention units or said second quantity of attention units based, at least in part, on said second entity's handling of a communication received by said second entity from said first entity.

27. The method of claim 26, wherein said changing at least one of said first quantity of attention units or said second quantity of attention units includes increasing said second quantity of attention units by a number of attention units associated with said communication.

28. The method of claim 26, wherein said changing at least one of said first quantity of attention units or said second quantity of attention units includes decreasing said first quantity of attention units by said number of attention units associated with said communication.

29. The method of claim 26, wherein said handling of said communication includes at least one of the following:
said second entity satisfying said communication; and
said second entity completing a criterion associated with said communication.

30. A system for facilitating attention to a communication, comprising:
a memory;
a communication port; and
a processor connected to said memory and said communication port, said processor being operative to:
associate a quantity of at least one attention unit to a first entity;
allow said first entity to provide a communication to a second entity, said communication including an associated number of at least one attention unit and at least one associated criterion; and
change a number of attention units associated with at least one of said first entity and said second entity when said criterion is satisfied.

31. A computer program product in a computer readable medium for facilitating attention to a communication, comprising:
first instructions for establishing an amount of at least one attention unit to a first entity;
second instructions for enabling said first entity to send a communication to a second entity having an associated number of at least one attention unit and an associated criterion; and
third instructions for altering a number of attention units associated with at least one of said first entity and said second entity said second criterion is satisfied.
